(19) United States
(12) Patent Application Publication
(10) Pub. No.: US 2006/0000531 A1
(43) Pub. Date: Jan. 5, 2006

(54) Pneumatic tire for heavy load

(76) Inventor: Naofumi Ezawa, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/509,868

(22) PCT Filed: Mar. 27, 2003
(86) PCT No.: PCT/JP03/03883

§ 371 Date: Aug. 16, 2005

(30) Foreign Application Priority Data
Apr. 1, 2002 (JP) 2002-98155

(51) Int. Cl. B60C 5/14; B60C 1/00; B60C 9/02

(52) U.S. Cl. 152/510; 152/565; 152/564

(57) ABSTRACT

In a heavy duty pneumatic tire comprising a carcass layer, an innerliner layer and an inner face protection layer arranged therebetween, the inner face protection layer is comprised of a rubber layer A and a rubber layer B, and a rubber composition constituting each layer is compounded with a rubber component, sulfur and a cobalt compound of an organic acid, and an amount of sulfur compounded satisfies the following equations (I) and (II):
S_{A}<S_{B}≦S_{C} (I)
2≦S_{A}≦4 (II)
(wherein S_{A}, S_{B} and S_{C} are an amount of sulfur compounded in a rubber composition constituting the rubber layer A, rubber layer B and the carcass layer, respectively, based on 100 parts by mass of the rubber component), and such a heavy duty pneumatic tire suppresses the creeping of the carcass rubber and also prevents the breakage of the inner face protection layer in the use at high-temperature, humid areas.

### TECHNICAL FIELD

This invention relates to a heavy duty pneumatic tire, and more particularly to a heavy duty pneumatic tire considerably improving a durability in use at warm and humid areas.

### BACKGROUND ART

In the conventional heavy duty pneumatic tire, an innerliner layer made from a butyl based rubber composition having a low air permeability is arranged as an innermost layer for holding an air pressure of the tire, and also an inner face protection layer is arranged between the innerliner layer and a carcass layer. The term “carcass layer” used herein means a carcass rubber portion of a carcass ply comprised of ply cords and a carcass rubber covering these ply cords.

The inner face protection layer is required to have a function of trapping oxygen so as not to arrive oxygen passing through the innerliner layer at the carcass ply to deteriorate an adhesion force between the ply cord and the carcass rubber, and a function of reinforcing the carcass rubber so as not to creep the carcass rubber outward in a radial direction due to the running of the tire or the internal tire pressure to stand out the ply cords toward the inner face of the tire. Also, the inner face protection layer is required to have a compounding near to that of the carcass rubber so as not to deteriorate the function inherent to the carcass ply due to the change of the carcass rubber composition before and after the vulcanization, and further a higher adhesion force to the innerliner layer made from the butyl based rubber composition before and after the vulcanization.

The oxygen trapping function is attained by deteriorating the rubber of the inner face protection layer itself through oxidation. However, as the fracture resistance of the inner face protection layer lowers due to the deteriorated through oxidation, if a large force is applied to the tire by riding over a projection in the last stage of the tire running or the like, the inner face protection layer is broken to bring about the tire troubles such as puncture and the like. Therefore, rubber having a high fracture resistance even in the deterioration through oxidation is desirable as a rubber for the inner face protection layer. Also, a rubber having a high elasticity and a high creep resistance is desirable as the rubber for the inner face protection layer in order to reinforce the carcass ply to suppress the occurrence of the creeping due to the tire running or the internal tire pressure.

In the pneumatic tire disclosed in Japanese Patent No. 2614441, the innerliner layer arranged inside the carcass layer has a three-layer structure of inner layer-middle layer-outer layer in which p-phenylene diamine based antioxidant is compounded in the middle layer at an amount of 5-30 parts by weight based on 100 parts by weight of a rubber component in order to provide a resistance to oxidation deterioration.

In JP-A-2001-121906 is disclosed a technique that an elastic reinforcing layer is arranged between the carcass ply and the innerliner layer and a copolymer consisting of one or more monomers containing a conjugated diene and one or more aromatic vinyl monomers is used in this reinforcing layer.

In JP-A-9-272308 and JP-A-10-297209 is disclosed a technique that the inner face protection layer is rendered into a two-layer structure and a cobalt compound of an organic acid is substantially removed from a rubber composition constituting a layer located side the innerliner layer to improve the resistance to oxidation deterioration of the inner face protection layer.

### DISCLOSURE OF THE INVENTION

However, Japanese Patent No.2614441 has a problem that p-phenylene diamine based antioxidant compounded in the middle layer is migrated during the vulcanization to adversely affect the adhesion between the ply cord and the carcass rubber.

In JP-A-2001-121906, there is a problem that the compounding cost of the elastic reinforcing layer becomes higher because of using the copolymer consisting of one or more monomers containing a conjugated diene and one or more aromatic vinyl monomers.

Even if the cobalt compound of the organic acid is substantially removed from the layer located side the innerliner layer as disclosed in JP-A-9-272308 and JP-A-10-297209, the effect of improving the resistance to oxidation deterioration in the inner face protection layer is not sufficient, and particularly there is remained a problem that the inner face protection layer is feared to be broken in high-temperature and humid areas.

It is, therefore, an object of the invention to provide a heavy duty pneumatic tire in which the inner face protection layer arranged between the carcass layer and the innerliner layer controls the creeping of the carcass rubber and also the resistance to oxidation deterioration is sufficiently high to prevent the occurrence of the breakage of the inner face protection layer even when being used in the high-temperature and humid areas.

The inventor has made various studies in order to achieve the above object and found that the inner face protection layer arranged between the innerliner layer and the carcass layer in the heavy duty pneumatic tire is rendered into a two-layer structure of a rubber layer adjacent to the innerliner layer and a rubber layer adjacent to the carcass layer, and the compounding of the rubber composition is changed between both the rubber layers to separate the functions of both the rubber layers so that the rubber layer adjacent to the carcass layer has a high creep resistance and a compounding near to that of the carcass layer so as to suppress the influence due to the difference of the compounding composition to the carcass layer and the rubber layer adjacent to the innerliner layer has a high fracture resistance even after the deterioration through oxidation, whereby the creeping of the carcass rubber can be suppressed and the resistance to oxidation deterioration can be further improved while maintaining the adhesion property between the ply cored and the carcass rubber, and as a result, the invention has been accomplished.

Namely, the invention lies in;

<1> A heavy duty pneumatic tire comprising a carcass layer, an innerliner layer and an inner face protection layer arranged therebetween, characterized in that the inner face protection layer is comprised of a rubber layer A adjacent to the innerliner layer and a rubber layer B adjacent to the carcass layer, and each of rubber layers constituting the innerliner layer, the carcass layer, the rubber layer A and the rubber layer B is compounded with a rubber component, sulfur and a cobalt compound of an organic acid, and an amount of sulfur compounded satisfies the following equations (I) and (II):
S_{A}<S_{B}≦S_{C} (I)
2≦S_{A}≦4 (II)
(wherein S_{A}, S_{B} and S_{C} are an amount of sulfur compounded in a rubber composition constituting the rubber layer A, rubber layer B and the carcass layer, respectively, based on 100 parts by mass of the rubber component).

<2> A heavy duty pneumatic tire according to the above item <1>, wherein S_{B} is not less than 4.

<3> A heavy duty pneumatic tire according to the above item <1>, wherein an elongation at break of the rubber composition constituting the rubber layer A is 1.00-1.45 times an elongation at break of the rubber composition constituting the rubber layer B.

### BEST MODE FOR CARRYING OUT THE INVENTION

The invention will be described in detail below.

The heavy duty pneumatic tire according to the invention comprises a pair of bead portions, a pair of side portions, a tread portion, a carcass ply toroidally extending between the bead portions, an innerliner layer, and an inner face protection layer arranged between a carcass layer constituting the carcass ply and the innerliner layer, in which the inner face protection layer is comprised of a rubber layer A adjacent to the innerliner layer and a rubber layer B adjacent to the carcass layer. Also, each of rubber compositions constituting the innerliner layer, carcass layer, rubber layer A and rubber layer B, respectively, is compounded with a rubber component, sulfur and a cobalt compound of an organic acid.

The rubber layer B plays a role that the rubber layer A and the carcass layer are separated from each other at a certain distance so that a bad influence due to the compounding difference between the rubber composition constituting the rubber layer A and the rubber composition constituting the carcass layer does not exert upon the carcass layer, and a role of reinforcing the carcass ply to suppress the creeping of the carcass rubber so as not to stand out ply cords toward an inner face of the tire.

On the other hand, the rubber layer A is sufficient to have the creep resistance lower than that of the rubber layer B because the creeping of the carcass rubber is suppressed by the rubber layer B, so that the compounding of the rubber composition constituting the rubber layer A gives weight to the fracture resistance after the deterioration through oxidation and hence the amounts of sulfur and cobalt compound of organic acid compounded can be made lower than those of the rubber layer B, and also the amount of a vulcanization accelerator compounded can be reduced. In case of giving weight to the fracture resistance, an elongation at break of the rubber composition constituting the rubber layer A is 1.00-1.45 times, preferably 1.02-1.45 times an elongation at break of the rubber composition constituting the rubber layer B. Moreover, oxygen passing through the innerliner layer is trapped with the rubber layer A, so that it hardly arrives at the carcass ply through the rubber layer B.

The rubber layer B according to the invention is made of a rubber composition equal or similar to the rubber composition constituting the carcass layer. In such a rubber composition, natural rubber or a rubber blend containing not less than 70% by mass of natural rubber is preferable as a rubber component. As the other rubber in case of the rubber blend are mentioned a synthetic poly-isoprene rubber, a polybutadiene rubber, a styrene-butadiene copolymer rubber and so on. Also, the cobalt compound of the organic acid to be compounded in the above rubber composition is usually compounded in the carcass rubber for the carcass ply reinforcing the ply cord (e.g. steel cord) as an adhesion promoter, and includes, for example, cobalt naphthenate, cobalt stearate, cobalt oleate, cobalt tallolate, cobalt resinate and the like. The compounding amount of the cobalt compound of the organic acid in the rubber composition is usually 0.1-2.0 parts by mass based on 100 parts by mass of the rubber component. Furthermore, the rubber composition contains 4-7 parts by mass of sulfur based on 100 parts by mass of the rubber component as a vulcanizing agent.

In the rubber composition constituting the rubber layer B and the carcass layer are properly compounded carbon black, a vulcanization accelerator, an antioxidant, a softening agent and the like in addition to the aforementioned rubber component, sulfur and the cobalt compound of the organic acid. As the carbon black are used FEF, HAF or ISAF grade, and a compounding amount thereof is usually 40-65 parts by mass based on 100 parts by mass of the rubber component.

The rubber composition constituting the rubber layer A according to the invention has substantially the same composition as in the rubber layer B, but the compounding amount of sulfur is decreased so as to satisfy a relationship for the compounding amount of sulfur as mentioned later in order to attain the separated functions of the rubber layer A and the rubber layer B and improve the fracture resistance after the deterioration through oxidation.

That is, the compounding amount of sulfur in the rubber composition constituting the rubber layer A is necessary to satisfy the following equations (I) and (II) to the compounding amount of sulfur in each rubber composition constituting the carcass layer and the rubber layer B from a viewpoint that the fracture resistance is improved after the deterioration through oxidation.
S_{A}<S_{B}≦S_{C} (I)
2≦S_{A}≦4 (II)

In the above formulae, S_{A}, S_{B}, S_{C} are an amount of sulfur compounded in a rubber composition constituting the rubber layer A, rubber layer B and the carcass layer, respectively, based on 100 parts by mass of the rubber component.

The inner face protection layer according to the invention is comprised of the rubber layer A and the rubber layer B having the aforementioned rubber composition to separate the functions of these layers from each other and sufficiently improve the resistance to oxidation deterioration in the rubber layer A, whereby there can be provided a heavy duty pneumatic tire considerably improving the durability in the use at warm and humid areas.

In order that the inner face protection layer according to the invention sufficiently develops the above effect, it is preferable that the rubber layer A has a thickness of 0.2-2 mm, and the thickness of the rubber layer B has a thickness of 0.2-2 mm. Also, it is preferable that a total thickness of the rubber layer A and the rubber layer B is within a range of 0.5-3.0 mm.

The following examples are given in illustration of the invention and are not intended as limitations thereof.

### EXAMPLES

Tires to be tested in Examples 1 and 2 and Comparative Examples 1 and 2 are tires for truck and bus having a tire size of 11R22.5 and a rib pattern, in which rubber layer A and rubber layer B and carcass layer are prepared according to a compounding recipe shown in Table 1. Moreover, the rubber layer A has a thickness of 0.3 mm and the rubber layer B has a thickness of 0.3 mm.

After each test tire is run on a drum over 100,000 km, the tire is cut to measure elongation at break of rubber in the rubber layers A and B, a sinking amount of ply cord and adhesion property to the ply cord by the following measuring methods to thereby obtain results shown in Tables 1 and 2.

(1) Elongation at Break of Rubber (According to JIS K6251-1993)

A JIS #3 sample is taken out from portions of the rubber layer A and B, respectively, and then an elongation at break thereof is measured by means of an Instron tension testing machine.

(2) Sinking Amount of Ply Cord

After only the innerliner layer is taken out from the tire after the running, an irregular state of the inner face protection layer is evaluated by an average value of a sinking amount (difference in vertical length between mountain portion and valley portion in the irregularity).

(3) Adhesion Property to Ply Cord

An adhesion force between ply cord and carcass rubber is evaluated by an adhesion ratio of the carcass rubber to the ply cord after an innermost ply is taken out from a shoulder portion of the tire.

The evaluation results of the tests of the above (1) to (3) are shown in Tables 1 and 2 by an index on the basis that Comparative Example 1 is 100. Moreover, the larger the index value in any test results, the better the property.

TABLE 1

| | | Carcass | Rubber | | | | |
|---|---|---|---|---|---|---|---|
| | | layer | layer B | Rubber layer A | | | |
| Natural rubber | | 100 | 100 | 100 | 100 | 100 | 100 |
| N326 (carbon black) | | 50 | 50 | 50 | 50 | 50 | 50 |
| Cobalt compound of | | 1.5 | 1.5 | 0 | 0 | 0 | 0 |
| organic acid | | | | | | | |
| Zinc white | | 8 | 6 | 6 | 6 | 6 | 6 |
| Antioxidant | | 1 | 1.5 | 1.5 | 1.5 | 1.5 | 1.5 |
| Vulcanization accel- | | 0.8 | 0.8 | 0.6 | 0.6 | 0.6 | 0.6 |
| erator | | | | | | | |
| Sulfur | | 5 | 5 | 4.5 | 3.5 | 2.5 | 1.5 |
| Elongation at | (%) | — | 400 | 392 | 440 | 500 | 600 |
| break of rubber | (index) | | 100 | 98 | 110 | 125 | 150 |

TABLE 2

| | Comparative | | | Comparative |
|---|---|---|---|---|
| | Example 1 | Example 1 | Example 2 | Example 2 |
| Sinking amount | 100 | 98 | 97 | 90 |
| of ply cord | | | | |
| Adhesion property | 100 | 100 | 100 | 90 |
| to ply cord | | | | |

In the tires of Examples 1 and 2, the sinking amount of ply cord is equal to that of Comparative Example 1, and also the adhesion property of carcass rubber to ply cord is equal to that of Comparative Example 1, while the elongation at break of rubber is largely improved and the fracture resistance is improved. On the other hand, in the tire of Comparative Example 2, the elongation at break of rubber is considerably improved to improve the fracture resistance, but since a modulus of elasticity is too low, the sinking amount of ply cord is deteriorated to a considerable extent, and further the adhesion property of carcass rubber to ply cord lowers.

### INDUSTRIAL APPLICABILITY

According to the invention, the durability of the heavy duty pneumatic tire can be considerably improved by improving the elongation at break of rubber in the rubber layer A adjacent to the innerliner layer participating to the resistance to oxidation deterioration in the inner face protection layer arranged between the innerliner layer and the carcass layer in the heavy duty pneumatic tire without deteriorating the adhesion property between ply cord and carcass rubber and the sinking amount of ply cord.

1. A heavy duty pneumatic tire comprising a carcass layer, an innerliner layer and an inner face protection layer arranged therebetween, characterized in that the inner face protection layer is comprised of a rubber layer A adjacent to the innerliner layer and a rubber layer B adjacent to the carcass layer, and each of rubber layers constituting the innerliner layer, the carcass layer, the rubber layer A and the rubber layer B is compounded with a rubber component, sulfur and a cobalt compound of an organic acid, and an amount of sulfur compounded satisfies the following equations (I) and (II):
S_{A}<S_{B}≦S_{C} (I)
2≦S_{A}≦4 (II)
(wherein S_{A}, S_{B} and S_{C} are an amount of sulfur compounded in a rubber composition constituting the rubber layer A, rubber layer B and the carcass layer, respectively, based on 100 parts by mass of the rubber component).

2. A heavy duty pneumatic tire according to claim 1, wherein S_{B} is not less than 4.

3. A heavy duty pneumatic tire according to claim 1, wherein an elongation at break of the rubber composition constituting the rubber layer A is 1.00-1.45 times an elongation at break of the rubber composition constituting the rubber layer B.
